(19) United States
(12) Patent Application Publication
(10) Pub. No.: US 2024/0126241 A1
(43) Pub. Date: Apr. 18, 2024

(54) NUMERICAL CONTROLLER

(71) Applicant: Fanuc Corporation, Minamitsuru-gun, Yamanashi (JP)

(72) Inventors: Nobuhito Oonishi, Minamitsuru-gun, Yamanashi (JP); Masashi Yasuda, Minamitsuru-gun, Yamanashi (JP); Kasumi Satou, Minamitsuru-gun, Yamanashi (JP)

(73) Assignee: Fanuc Corporation, Minamitsuru-gun, Yamanashi (JP)

(21) Appl. No.: 18/278,214

(22) PCT Filed: Mar. 14, 2022
(86) PCT No.: PCT/JP2022/011251

§ 371 Date: Aug. 22, 2023

(30) Foreign Application Priority Data
Mar. 16, 2021 (JP) 2021-042936

(51) Int. Cl. G05B 19/4155; G05B 19/19; G05B 19/416

(52) U.S. Cl. CPC G05B 19/4155; G05B 19/19; G05B 19/416

(57) ABSTRACT

A numerical controller includes a region information reception unit configured to receive input of data defining a control region in which a control condition is set in a movement region of an axis of a machine tool, a region setting unit configured to set the control region based on the data received by the region information reception unit, a control condition setting unit configured to set the control condition in the control region, and a command generation unit configured to generate a control command in the control region based on the control condition.

### CROSS REFERENCE TO RELATED APPLICATIONS

This is the U.S. National Phase application of PCT/JP2022/011251, filed Mar. 14, 2022, which claims priority to Japanese Patent Application No. 2021-042936, filed Mar. 16, 2021, the disclosures of each of these applications being incorporated herein by reference in their entireties for all purposes.

### FIELD OF THE INVENTION

The present invention relates to a numerical controller for controlling a machine tool.

### BACKGROUND OF THE INVENTION

In a machining program used for machining a workpiece, predetermined code is used to designate a movement path of a tool and a control condition when the tool moves along the movement path (for example, Patent Document 1).

### PATENT DOCUMENT

Patent Document 1: JP 2017-156835 A

### SUMMARY OF THE INVENTION

However, when a control condition for a part of a movement path designated by a machining program is changed, it is necessary to specify a block, a control condition of which is to be changed, in the machining program. For example, when a machining condition for a part of a surface of a workpiece is changed, a block that designates machining of this part needs to be specified on the machining program. In this case, an operator performs an operation of searching for a block to be changed from a lot of blocks. Therefore, it becomes a heavy burden on the operator.

An object of the present disclosure is to provide a numerical controller capable of easily designating a control condition for a part of a movement path designated by a machining program.

A numerical controller includes a region information reception unit configured to receive input of data defining a control region in which a control condition is set in a movement region of an axis of a machine tool, a region setting unit configured to set the control region based on the data received by the region information reception unit, a control condition setting unit configured to set the control condition in the control region, and a command generation unit configured to generate a control command in the control region based on the control condition.

According to the present disclosure, it is possible to easily set a control condition for a part of a movement path designated by a machining program.

### BRIEF DESCRIPTION OF DRAWINGS

FIG. 1 is a diagram illustrating an example of a hardware configuration of a machine tool;

FIG. 2 is a block diagram illustrating an example of functions of a numerical controller;

FIG. 3 is a diagram for describing an example of data defining a control region;

FIG. 4 is a diagram for describing an example of a movement path of a tool specified by a path specification unit;

FIG. 5 is a diagram for describing an example of dividing a movement path;

FIG. 6 is a diagram for describing a tolerance in a smoothing process;

FIG. 7 is a diagram for describing an example of a control command generated by a command generation unit;

FIG. 8 is a flowchart illustrating an example of a flow of processing executed in the numerical controller;

FIG. 9 is a block diagram illustrating an example of functions of the numerical controller; and

FIG. 10 is a diagram for describing an example of the control region.

### DETAILED DESCRIPTION OF EMBODIMENTS OF THE INVENTION

An embodiment of the disclosure will be described below with reference to the drawings. Note that not all combinations of features described in the following embodiment are necessarily required to solve the problem. Further, more detailed description than necessary may be omitted. In addition, the following description of the embodiment and drawings are provided for those skilled in the art to fully understand the disclosure, and are not intended to limit the scope of the claims.

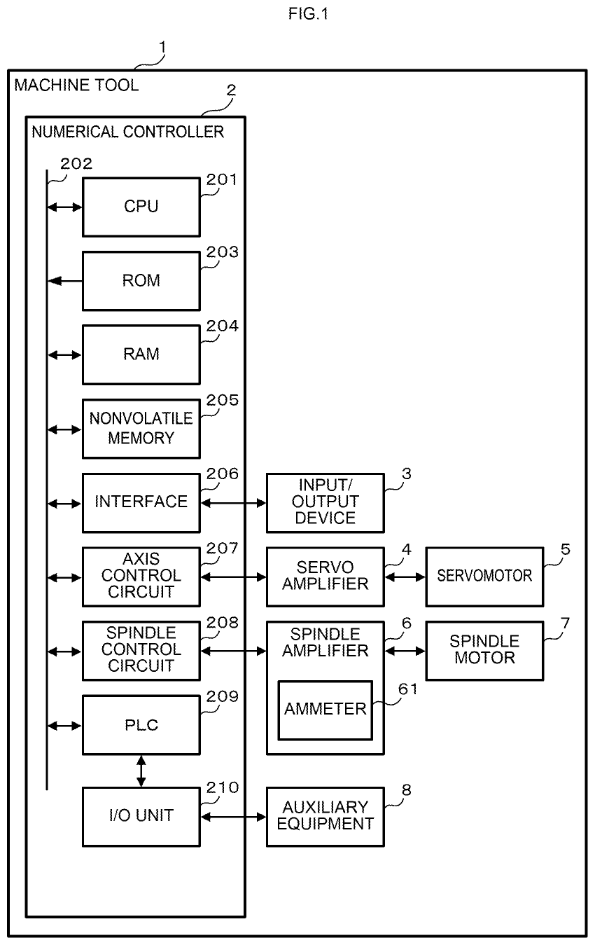

FIG. 1 is a diagram illustrating an example of a hardware configuration of a machine tool. A machine tool 1 is, for example, a lathe, a machining center, a multitasking machine, and an electric discharge machine.

The machine tool 1 includes, for example, a numerical controller 2, an input/output device 3, a servo amplifier 4 and a servomotor 5, a spindle amplifier 6 and a spindle motor 7, and auxiliary equipment 8.

The numerical controller 2 is a device that controls the entire machine tool 1. The numerical controller 2 includes a CPU (Central Processing Unit) 201, a bus 202, a ROM (Read Only Memory) 203, a RAM (Random Access Memory) 204, and a nonvolatile memory 205.

The CPU 201 is a processor that controls the entire numerical controller 2 according to a system program. The CPU 201 reads a system program, etc. stored in the ROM 203 via the bus 202. In addition, the CPU 201 controls the servomotor 5 and the spindle motor 7 based on a machining program.

The CPU 201, for example, analyzes the machining program and outputs a control command to the servomotor 5 for each control cycle.

The bus 202 is a communication path that connects respective pieces of hardware in the numerical controller 2 to each other. Respective pieces of hardware in the numerical controller 2 exchanges data via the bus 202.

The ROM 203 is a storage device that stores a system program, etc. for controlling the entire numerical controller 2. The ROM 203 is a computer-readable storage medium.

The RAM 204 is a storage device that temporarily stores various data. The RAM 204 functions as a work area for the CPU 201 to process various data.

The nonvolatile memory 205 is a storage device that retains data even when the power of the machine tool 1 is turned off and power is not supplied to the numerical controller 2. The nonvolatile memory 205 stores, for example, a machining program and various parameters input from the input/output device 3. The nonvolatile memory 205 is a computer-readable storage medium. The nonvolatile memory 205 includes, for example, an SSD (Solid State Drive).

The numerical controller 2 further includes an interface 206, an axis control circuit 207, a spindle control circuit 208, a PLC (Programmable Logic Controller) 209, and an I/O unit 210.

The interface 206 connects the bus 202 and the input/output device 3 to each other. For example, the interface 206 transmits various data processed by the CPU 201 to the input/output device 3.

The input/output device 3 is a device that receives various data via the interface 206 and displays the various data. In addition, the input/output device 3 receives input of various data and transmits the various data to the CPU 201 via the interface 206. The input/output device 3 includes a display such as an LCD (Liquid Crystal Display), a keyboard, a mouse, etc. In addition, the input/output device 3 may be a touch panel.

The axis control circuit 207 is a circuit that controls the servomotor 5. The axis control circuit 207 receives a control command from the CPU 201 and outputs a command for driving the servomotor 5 to the servo amplifier 4. For example, the axis control circuit 207 transmits a torque command for controlling the torque of the servomotor 5 to the servo amplifier 4.

The servo amplifier 4 receives a command from the axis control circuit 207 and supplies current to the servomotor 5.

The servomotor 5 is driven by being supplied with current from the servo amplifier 4. The servomotor 5 is connected to, for example, a ball screw that drives a tool post, a spindle head, and a table. By driving the servomotor 5, structures of the machine tool 1 such as the tool post, the spindle head, and the table move, for example, in an X-axis direction, a Y-axis direction, or a Z-axis direction. Note that the servomotor 5 may incorporate a speed detector (not illustrated) for detecting a feed rate of each axis.

The spindle control circuit 208 is a circuit for controlling the spindle motor 7. The spindle control circuit 208 receives a control command from the CPU 201 and outputs a command for driving the spindle motor 7 to the spindle amplifier 6. The spindle control circuit 208, for example, transmits a torque command for controlling the torque of the spindle motor 7 to the spindle amplifier 6.

The spindle amplifier 6 receives a command from the spindle control circuit 208 and supplies current to the spindle motor 7. The spindle amplifier 6 incorporates an ammeter 61 that measures a current value of the current supplied to the spindle motor 7.

The ammeter 61 detects the current value of the current supplied to spindle motor 7. The ammeter 61 transmits data indicating the detected current value to the CPU 201.

The spindle motor 7 is driven by being supplied with current from the spindle amplifier 6. The spindle motor 7 is coupled to a spindle to rotate the spindle.

The PLC 209 is a device that executes a ladder program to control the auxiliary equipment 8. The PLC 209 transmits a command to the auxiliary equipment 8 via the I/O unit 210.

The I/O unit 210 is an interface that connects the PLC 209 and the auxiliary equipment 8 to each other. The I/O unit 210 transmits a command received from the PLC 209 to the auxiliary equipment 8.

The auxiliary equipment 8 is installed in the machine tool 1 and performs an auxiliary operation in the machine tool 1. The auxiliary equipment 8 may be a device installed around the machine tool 1. The auxiliary equipment 8 operates based on a command received from the I/O unit 210. The auxiliary equipment 8 is, for example, a tool changer, a cutting fluid injection device, or an opening/closing door driving device.

Next, an example of functions of the numerical controller 2 will be described.

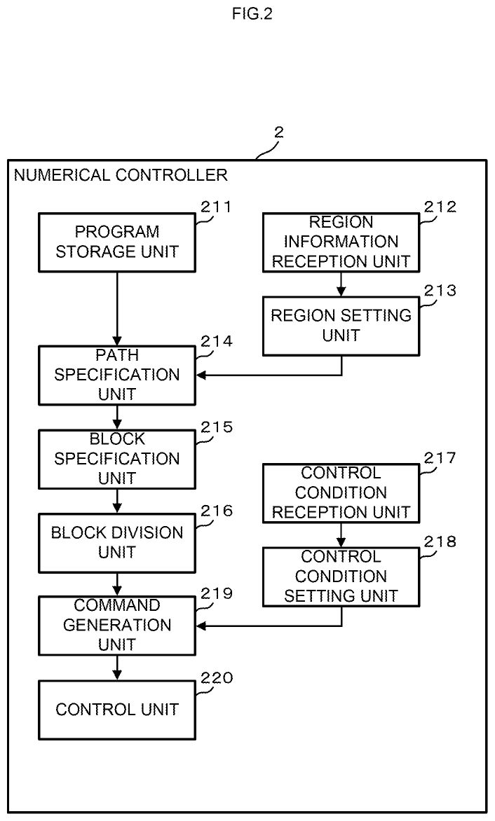

FIG. 2 is a block diagram illustrating the example of the functions of the numerical controller 2. The numerical controller 2 includes a program storage unit 211, a region information reception unit 212, a region setting unit 213, a path specification unit 214, a block specification unit 215, a block division unit 216, a control condition reception unit 217, a control condition setting unit 218, a command generation unit 219, and a control unit 220.

The program storage unit 211 is realized by a machining program input from the input/output device 3, etc. being stored in the RAM 204 or the nonvolatile memory 205.

For example, the region information reception unit 212, the region setting unit 213, the path specification unit 214, the block specification unit 215, the block division unit 216, the control condition reception unit 217, the control condition setting unit 218, the command generation unit 219, and the control unit 220 are realized by the CPU 201 performing arithmetic processing using a system program stored in the ROM 203 and various data stored in the nonvolatile memory 205.

The program storage unit 211 stores a machining program. The machining program is a program for operating each unit of the machine tool 1 to machine a workpiece. In the machining program, control conditions such as a movement path of a tool, a speed of the spindle, a feed rate, control conditions for respective function, etc. are designated using G code, S code, F code, code defined for each function, etc.

The region information reception unit 212 receives input of data defining a control region in a movement region of an axis of the machine tool 1. The movement region of the axis is a region in which the axis is movable in a coordinate system set in the machine tool 1. The control region is a region in which a control condition is set in the movement region of the axis. In other words, in the control region in which the control condition is set, each unit is controlled based on the control condition.

For example, when a part of the workpiece is set as the control region, the workpiece is machined based on the control condition in the part set as the control region. For example, the region information reception unit 212 receives input of coordinate values in a workpiece coordinate system as data defining the control region. For example, the region information reception unit 212 receives input of the data defining the control region from the input/output device 3.

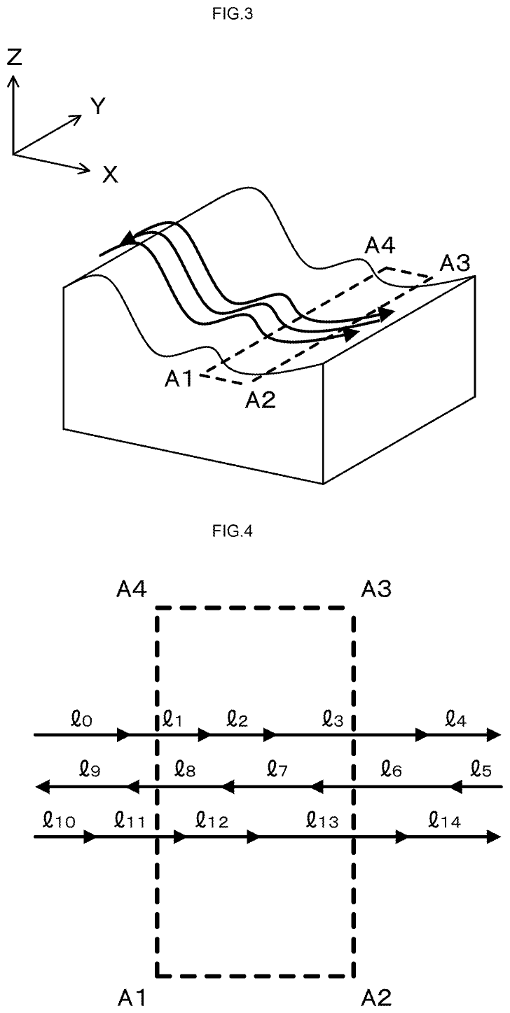

FIG. 3 is a diagram for describing data defining the control region. The region information reception unit 212 receives, for example, input of coordinate values for defining a partial region on a free-form surface forming an upper surface of the workpiece as a control region. For example, the region information reception unit 212 receives input of coordinate values (X_{A1}, Y_{A1}), (X_{A2}, Y_{A2}), (X_{A3}, Y_{A3}), and (X_{A4}, Y_{A4}) indicating positions of points A1, A2, A3, and A4 on an X-Y plane.

The region setting unit 213 sets a control region in which a control condition is set in a movement region of the axis of the machine tool 1 based on the data defining the control region received by the region information reception unit 212. When the region information reception unit 212 receives input of coordinate values of four points in the X-Y plane, the region setting unit 213 specifies a space, an X coordinate and a Y coordinate of which are surrounded by the four points, in the movement region of the axis. In other words, when a frame having the four points as vertices is moved along a Z-axis, the region setting unit 213 specifies a region cut out by this frame. The region setting unit 213 sets the specified region as a control region.

The path specification unit 214 analyzes the machining program, and specifies a movement path included in the control region set by the region setting unit 213 in a movement path of the axis commanded by the machining program.

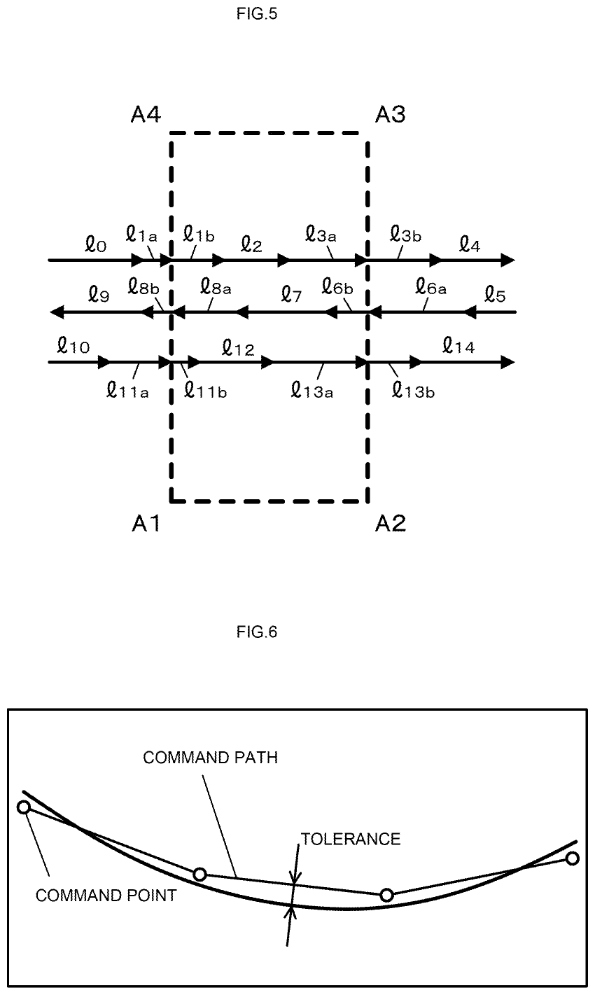

FIG. 4 is a diagram for describing a movement path of the axis specified by the path specification unit 214. Each of arrows l₀ to l₄, l₅ to l₉, and l₁₀ to l₁₄ indicates a movement path of the axis commanded by each block of the machining program. The path specification unit 214 specifies a movement path at least partially included in the control region. In an example illustrated in FIG. 4, the path specification unit 214 specifies movement paths l₁ to l₃, l₆ to l₈, and l₁₁ to l₁₃. Note that a block in the machining program means, for example, each line of the machining program to which a sequence number is assigned.

The block specification unit 215 specifies a command block that commands the movement path specified by the path specification unit 214 from blocks of the machining program. For example, the block specification unit 215 specifies the command block by extracting a block that commands coordinate values included in the control region in the machining program. In an example illustrated in FIG. 4, the block specification unit 215 specifies blocks that command the movement paths l₁ to l₃, l₆ to l₈, and l₁₁ to l₁₃.

For example, when the movement paths l₁ to l₃, l₆ to l₈, and l₁₁ to l₁₃ are commanded by blocks of sequence numbers N0011 to N0013, N0111 to N0113, and N0211 to N0213, respectively, the block specification unit 215 specifies the blocks of the sequence numbers N0011 to N0013, N0111 to N0113, and N0211 to N0213.

When a movement path commanded by a command block straddles an outside and an inside of the control region, the block division unit 216 divides the movement path commanded by the command block into an outside path not included in the control region and an inside path included in the control region.

FIG. 5 is a diagram for describing an example of dividing a movement path. The block division unit 216 divides the movement paths l₁, l₃, l₆, l₈, l₁₁, and l₁₃ that straddle the outside and the inside of the control region at a boundary of the control region. The block division unit 216 divides l₁ into l₁ₐ and l_{1b}. Similarly, the block division unit 216 divides l₃ into l₃ₐ and l_{3b}, l₆ into l₆ₐ and l_{6b}, l₈ into l₈ₐ and l_{8b}, l₁₁ into l₁₁ₐ and l_{11b}, and l₁₃ into l₁₃ₐ and l_{13b}.

The control condition reception unit 217 receives input of a control condition to be set in the control region. The control condition is, for example, a machining condition. For example, the machining condition includes the number of rotations of the spindle and a feed rate. In addition, the control condition may include a speed control parameter, a servo parameter, a control parameter defined for each function, and a parameter indicating an ON/OFF state of each function. The speed control parameter includes a permissible speed of each axis, permissible acceleration of each axis, permissible jerk of each axis, permissible tangential acceleration, permissible normal acceleration, etc. When the movement path of the tool draws a curve, the permissible tangential acceleration is the maximum permissible acceleration of the tool in a tangential direction of this curve. In addition, when the movement path of the tool draws a curve, the permissible normal acceleration is the maximum permissible acceleration of the tool in a normal direction of this curve. The servo parameter includes a parameter related to transfer characteristics in servo control, such as position loop gain or feedforward gain. For example, the control parameter defined for each function includes a tolerance in a smoothing process, etc. Further, for example, the parameter indicating the ON/OFF state of the function includes a parameter indicating an ON/OFF state of oscillating motion. Note that the oscillating motion is motion of oscillating at least one of the tool and the workpiece to cut chips during machining of the workpiece.

Here, the smoothing process will be described. The smoothing process is a process for smoothing the movement path so that the movement path commanded by the machining program becomes smooth. For example, when the movement path is formed by a plurality of mutually connected minute line segments, the movement path is smoothed by converting the movement path into a spline curve. In this instance, a tolerance is an allowable difference between the curve generated by smoothing and the movement path formed by the original minute line segments.

FIG. 6 is a diagram for describing the tolerance in the smoothing process. FIG. 6 illustrates the movement path formed by the interconnected minute line segments and the curve generated by performing the smoothing process on the movement path. When the tolerance is large, the generated curve becomes smoother. Conversely, when the tolerance is small, the generated curve becomes a curve having a shape that approximates the movement path including the original minute line segments.

Here, the description returns to the description of FIG. 2.

The control condition setting unit 218 sets the control condition received by the control condition reception unit 217 as a control condition in the control region. For example, when the control condition reception unit 217 receives a control condition for setting a tolerance to 1 [μm], the control condition setting unit 218 sets a tolerance in the control region to 1 [μm]. In addition, when the control condition reception unit 217 receives a control condition for setting a feed rate to 1000 [mm/min], the control condition setting unit 218 sets a feed rate in the control region to 1000 [mm/min].

The command generation unit 219 generates a control command in the control region based on the control condition set by the control condition setting unit 218.

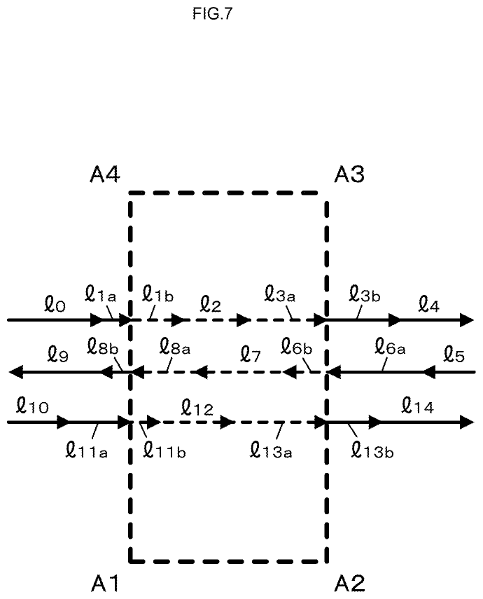

FIG. 7 is a diagram for describing an example of a control command generated by the command generation unit 219. The command generation unit 219 generates a control command for a movement path included in the control region. The command generation unit 219 generates control commands for movement paths l_{1b}, l₂, l₃ₐ, l_{6b}, l₇, l₈ₐ, l_{11b}, l₁₂, and l₁₃ₐ in the control region based on control conditions.

When the tolerance is set to 1 [μm] as the control condition, the command generation unit 219 generates control commands for the movement paths l_{1b}, l₂, and l₃ₐ, control commands for the movement paths l_{6b}, l₇, and l₈ₐ, and control commands for the movement paths l_{11b}, l₁₂, and l₁₃ₐ so that the tolerance becomes 1 [μm].

The command generation unit 219 generates a control command for a region other than the control region based on a command written in each block of the machining program. For example, when a tolerance of the region other than the control region is set to 2 [μm], the command generation unit 219 generates control commands for the movement paths l₀ and l₁ₐ, control commands for the movement paths l_{3b} and l₄, control commands for the movement paths l₅ and l₆ₐ, control commands for l_{8b} and l₉, control commands for l₁₀ and l₁₁ₐ, and control commands for the movement paths l_{13b} and l₁₄ so that the magnitude of the tolerance becomes 2 [μm].

The control unit 220 controls movement of the axis in the control region based on a command generated by the command generation unit 219. In addition, the control unit 220 controls movement of the axis in a region other than the control region based on a command generated by the command generation unit 219.

For example, when the axis is moved along the movement paths illustrated in FIG. 7, the control unit 220 first moves the axis in the order of the movement paths l₀, l₁ₐ, l_{1b}, l₂, l₃ₐ, l_{3b}, and l₄ drawn in an upper row. At this time, the control unit 220 moves the axis so that the tolerance in the control region becomes 1 [μm], and the tolerance in a region other than the control region becomes 2 [μm].

Next, the control unit 220 moves the axis in the order of the movement paths l₅, l₆ₐ, l_{6b}, l₇, l₈ₐ, l_{8b}, and l₉ drawn in the middle. At this time, the control unit 220 moves the axis so that the tolerance in the control region becomes 1 [μm], and the tolerance in a region other than the control region becomes 2 [μm].

Next, the control unit 220 moves the axis in the order of the movement paths l₁₀, l₁₁ₐ, l_{11b}, l₁₂, l₁₃ₐ, l_{13b}, and l₁₄ drawn in a lower row. At this time, the control unit 220 moves the axis so that the tolerance in the control region becomes 1 [μm], and the tolerance in a region other than the control region becomes 2 [μm].

Next, a flow of processing executed in the numerical controller 2 will be described.

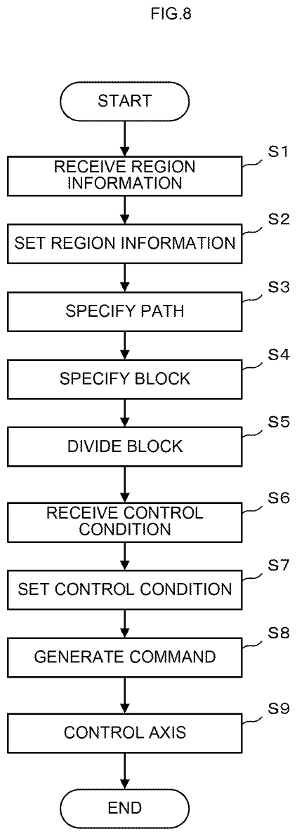

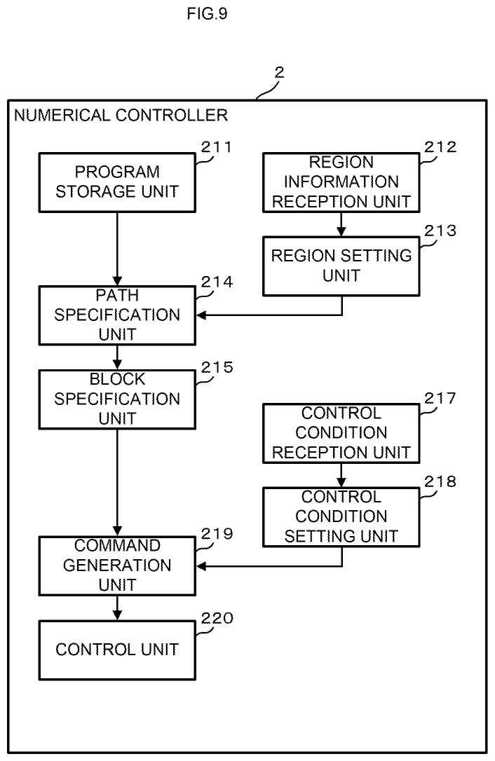

FIG. 8 is a flowchart illustrating an example of a flow of processing executed by the numerical controller 2. In the numerical control device 2, first, the region information reception unit 212 receives input of data defining a control region (step S1).

Next, the region setting unit 213 sets a control region in which a control condition is set based on the data defining the control region (step S2).

Next, the path specification unit 214 analyzes the machining program, and specifies a movement path included in the control region set by the region setting unit 213 (step S3).

Next, the block specification unit 215 specifies a command block that commands the movement path specified by the path specification unit 214 from blocks of the machining program (step S4).

Next, the block division unit 216 divides the movement path commanded by the command block into an outside path not included in the control region and an inside path included in the control region (step S5).

Next, the control condition reception unit 217 receives input of a control condition to be set in the control region (step S6).

Next, the control condition setting unit 218 sets the control condition received by the control condition reception unit 217 as a control condition in the control region (step S7).

Next, the command generation unit 219 generates a control command in the control region based on the control condition set by the control condition setting unit 218 (step S8).

Next, the control unit 220 controls the axis based on the control command generated by the command generation unit 219 (step S9), and the process ends.

As described above, the numerical controller 2 includes the region information reception unit 212 that receives input of data defining a control region in which a control condition is set in a movement region of the axis of the machine tool 1, the region setting unit 213 that sets a control region based on the data received by the region information reception unit 212, the control condition setting unit 218 that sets a control condition in the control region, and the command generation unit 219 that generates a control command in the control region based on the control condition. Therefore, the numerical controller 2 can set the control region in which the control condition is set, and set the control condition in the control region. In this way, an operator can easily set a control condition in a specific region.

In addition, the numerical controller 2 further includes the path specification unit 214 that analyzes a machining program, and specifies a movement path of the axis included in the control region, and the block specification unit 215 that specifies a command block for commanding the movement path specified by the path specification unit 214 from blocks of the machining program, and the command generation unit 219 generates a control command on the movement path commanded by the command block based on the control condition. Therefore, a correspondence relationship between the machining region of the workpiece and the blocks of the machining program can be easily understood. As a result, the operator can easily set a control condition in a specific region.

In addition, the numerical controller 2 further includes the block division unit 216 that divides a movement path straddling the outside and the inside of the control region into the outside path not included in the control region and the inside path included in the control region, and the command generation unit 219 generates a control command in the inside path based on a control condition. For this reason, even when the movement path commanded by the machining program straddles the outside and the inside of the control region, control conditions can be switched between the inside of the control region and a region other than the control region.

In addition, the control condition includes at least one of a machining condition, a speed control parameter, a servo parameter, a control parameter defined for each function, and a parameter indicating an ON/OFF state of a function. For this reason, these control conditions can be freely set in the control region.

In addition, the machining condition includes at least one of a speed of the spindle and a feed rate. In addition, the speed control parameter includes at least one of a permissible speed of the axis, permissible acceleration of the axis, permissible jerk of the axis, permissible tangential acceleration, and permissible normal acceleration. In addition, the servo parameter includes at least one of position loop gain and feedforward gain. In addition, the control parameter defined for each function includes a tolerance of the smoothing process. Further, the parameter indicating the ON/OFF state of the function includes a parameter indicating an ON/OFF state of the oscillating motion. Therefore, various control conditions can be set in the control region.

In the above-described embodiment, the region information reception unit 212 receives input of coordinate values as data defining the control region. However, for example, the region information reception unit 212 may receive input of actual tool position information as data defining the control region.

For example, when the tool is moved to four points on the X-Y plane, the region information reception unit 212 may receive these four points as data defining the control region. In this case, the region setting unit 213 sets a space, an X coordinate and a Y coordinate of which are included in a region surrounded by the four points, as the control region.

In addition, when the numerical controller 2 holds CAD (Computer Aided Design) data indicating the movement region of the axis and a shape of the workpiece, the region information reception unit 212 may receive a position designated on the CAD data as data defining the control region. In this case, the operator can define the control region by designating, for example, four points on a screen of the input/output device 3 on which an image of the movement region of the axis and the workpiece is displayed.

Even though the numerical controller 2 of the embodiment described above includes the block division unit 216, the numerical controller 2 does not necessarily have to include the block division unit 216.

FIG. 9 is a block diagram illustrating an example of functions of the numerical controller 2. Note that the numerical controller 2 illustrated in FIG. 2 and the numerical controller 2 illustrated in FIG. 9 are the same except that the numerical controller 2 illustrated in FIG. 9 does not include the block division unit 216.

The program storage unit 211 stores a machining program. The region information reception unit 212 receives input of data defining the control region in the movement region of the axis of the machine tool 1.

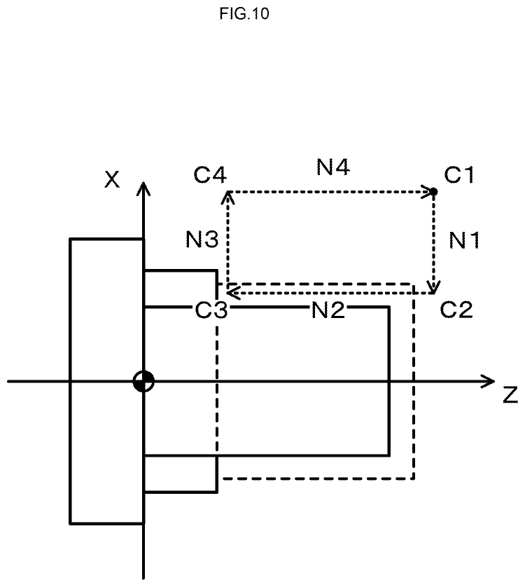

FIG. 10 is a diagram for describing an example of the control region. FIG. 10 illustrates a state in which a chuck of the lathe holds a cylindrical workpiece.

For example, the region information reception unit 212 receives input of data indicating a shape of a workpiece before machining held by the chuck as data defining the control region. For example, when the shape of the workpiece is a cylindrical shape, the region information reception unit 212 receives input of coordinate values of point B indicating a total length and a size of an outer diameter of the workpiece.

The region setting unit 213 sets a control region in which a control condition is set in the movement region of the axis of the machine tool 1 based on the data defining the control region received by the region information reception unit 212. In the example illustrated in FIG. 10, the entire region occupied by the workpiece is set as the control region.

The path specification unit 214 analyzes the machining program, and specifies a movement path included in the control region set by the region setting unit 213 among movement paths of the axis commanded in the machining program. In addition, the path specification unit 214 may specify a movement path not included in the control region. The path specification unit 214 analyzes the machining program, and specifies, for example, movement paths N1, N2, N3, and N4.

The block specification unit 215 specifies a command block that commands the movement path included in the control region specified by the path specification unit 214 from the blocks of the machining program.

The control condition reception unit 217 receives input of a control condition in the control region. The control condition reception unit 217 receives, for example, a movement condition of the axis as the control condition. The movement condition of the axis is information for commanding cutting feed. In other words, the control condition reception unit 217 receives input of a control condition instructing that the tool be controlled by cutting feed in the control region.

The control condition reception unit 217 may receive input of information indicating a control mode in the control region. The control mode means setting states of a plurality of control conditions. In other words, when the control mode is different, a setting state of at least one of the plurality of control conditions is different.

The control condition reception unit 217 receives input of information indicating, for example, a positioning mode or a cutting feed mode as the control mode. The positioning mode is a mode in which the axis is moved by rapid traverse. The cutting feed mode is a mode in which the axis is moved by cutting feed.

The control condition setting unit 218 sets the control condition or the control mode received by the control condition reception unit 217 as a control condition or a control mode in the control region.

The control condition setting unit 218 sets, for example, the control condition in the control region to cutting feed based on the control condition received by the control condition reception unit 217. In addition, the control condition setting unit 218 sets the control condition in the region other than the control region to rapid traverse.

Further, for example, the control condition setting unit 218 sets the control mode in the control region to the cutting feed mode based on the control mode received by the control condition reception unit 217. In addition, the control condition setting unit 218 sets the control mode in the region other than the control region to the positioning mode. In other words, the control condition setting unit 218 sets the control mode in the control region to a control mode different from the control mode in the region other than the control region.

Note that at least one control condition among control conditions such as a speed control parameter, a servo parameter, a control parameter defined for each function, and a parameter indicating an ON/OFF state of a function is different between the case where the axis of the numerical controller 2 is moved by cutting feed and the case where the axis of the numerical controller 2 is moved by rapid traverse. In other words, the control condition setting unit 218 sets at least one of a speed control parameter, a servo parameter, a control parameter defined for each function, and a parameter indicating an ON/OFF state of a function to different set values between the control region and the region other than the control region.

The command generation unit 219 generates a control command in the control region based on the control condition set by the control condition setting unit 218. In addition, the command generation unit 219 generates a control command in the control region based on the control mode set by the control condition setting unit 218. The command generation unit 219 generates, for example, a command for moving the tool by cutting feed on a movement path at least partially included in the control region. That is, movement of the axis along the movement path at least partially included in the control region is performed in the cutting feed mode. In addition, the command generation unit 219 generates a command for moving the tool by rapid traverse on a movement path outside the control region. That is, movement of the axis on the movement path outside the movement region is performed in the positioning mode.

The control unit 220 controls movement of the axis in the control region based on a cutting feed command generated by the command generation unit 219. In addition, the control unit 220 controls movement of the axis in a region other than the control region based on a positioning command generated by the command generation unit 219.

For example, in the example illustrated in FIG. 10, the movement path N1 is a movement path outside the control region. Therefore, on the movement path N1, the control unit 220 moves the axis by rapid traverse. In addition, a part of the movement path N2 is included in the control region. Therefore, the control unit 220 moves the axis by cutting feed on the movement path N2. In addition, a part of the movement path N3 is included in the control region. Therefore, the control unit 220 moves the axis by cutting feed in N3. In addition, the movement path N4 is a movement path outside the control region. Therefore, the control unit 220 moves the axis by rapid traverse on the movement path N4. In other words, the control unit 220 switches the control mode between the control region and the region other than the control region.

As described above, the control condition setting unit 218 sets the control mode in the control region to the cutting feed mode, and sets the control mode in the region other than the control region to the positioning mode. In this case, the numerical controller 2 can move the tool by cutting feed in the control region, and move the tool by rapid traverse in the region other than the control region. Therefore, the machining program does not need to command a positioning command GOO and a cutting feed command G01. As a result, the amount of program code can be reduced.

That is, the control condition setting unit 218 sets the control condition to different set values based on the set control mode between the control region and the region other than the control region. In this way, machining accuracy and a machining time can be set to desired accuracy and time, respectively.

In the embodiment described above, the control condition setting unit 218 sets the control condition to rapid traverse in the region other than the control region. However, the control condition setting unit 218 does not necessarily have to set the control condition to rapid traverse in the region other than the control region. For example, the control condition setting unit 218 may provide a priority indicator of a switching condition for a control mode in each of the inside of the control region and the outside of the control region, and switch the control mode based on the priority indicator. In other words, the control condition setting unit 218 may switch the control mode based on the priority indicator. In addition, the priority indicator may include an execution time.

For example, in the example illustrated in FIG. 10, after movement of the axis is controlled by cutting feed on the movement path N3, the control condition is switched, and movement of the axis is controlled by rapid traverse on the movement path N4. In this instance, it takes a short time to switch the control condition. Therefore, for example, when the movement path N4 is short, a time required to complete machining is shortened by performing control on the movement paths N3 and N4 without switching the control condition. Therefore, when an execution time is set as a priority indicator of a switching condition for a control mode on the outside of the control region, the control mode on the outside of the control region is switched to the cutting feed mode so that an execution time of the machining program is shortened. In other words, when it is determined that, by controlling movement of the axis by cutting feed rather than rapid traverse on at least one movement path other than the control region, a time required to complete movement of the axis on the movement path is shortened, the control condition setting unit may set the control condition to cutting feed on the movement path.

In the above-described embodiment, when it is determined that, by controlling the axis by cutting feed rather than rapid traverse on a movement path other than the control region, a time required to complete machining is shortened, the control condition setting unit 218 sets the control condition on the movement path other than the control region to cutting feed. In this way, it is possible to reduce a load on a control condition switching process. Moreover, a workpiece machining time can be shortened.

### EXPLANATIONS OF LETTERS OR NUMERALS

1 MACHINE TOOL
2 NUMERICAL CONTROLLER
201 CPU
202 BUS
203 ROM
204 RAM
205 NONVOLATILE MEMORY
206 INTERFACE
207 AXIS CONTROL CIRCUIT
208 SPINDLE CONTROL CIRCUIT
209 PLC
210 I/O UNIT
211 PROGRAM STORAGE UNIT
212 REGION INFORMATION RECEPTION UNIT
213 REGION SETTING UNIT
214 PATH SPECIFICATION UNIT
215 BLOCK SPECIFICATION UNIT
216 BLOCK DIVISION UNIT
217 CONTROL CONDITION RECEPTION UNIT
218 CONTROL CONDITION SETTING UNIT
219 COMMAND GENERATION UNIT
220 CONTROL UNIT
3 INPUT/OUTPUT DEVICE
4 SERVO AMPLIFIER
5 SERVOMOTOR
6 SPINDLE AMPLIFIER
61 AMMETER
7 SPINDLE MOTOR
8 AUXILIARY EQUIPMENT

1. A numerical controller comprising:
a region information reception unit configured to receive input of data defining a control region in which a control condition is set in a movement region of an axis of a machine tool;
a region setting unit configured to set the control region based on the data received by the region information reception unit;
a control condition setting unit configured to set the control condition in the control region; and
a command generation unit configured to generate a control command in the control region based on the control condition.

2. The numerical controller according to claim 1, further comprising:
a path specification unit configured to analyze a machining program, and specify a movement path of the axis included in the control region; and
a block specification unit configured to specify a command block for commanding the movement path specified by the path specification unit from blocks of a machining program,
wherein the command generation unit generates the control command on the movement path commanded by the command block based on the control condition.

3. The numerical controller according to claim 2, further comprising:
a block division unit configured to divide the movement path straddling an outside and an inside of the control region into an outside path not included in the control region and an inside path included in the control region,
wherein the command generation unit generates the control command on the inside path based on the control condition.

4. The numerical controller according to claim 1, wherein the control condition includes at least one of a machining condition, a speed control parameter, a servo parameter, a control parameter defined for each function, and a parameter indicating an ON/OFF state of a function.

5. The numerical controller according to claim 4, wherein the machining condition includes at least one of a speed of a spindle and a feed rate, the speed control parameter includes at least one of a permissible speed of the axis, permissible acceleration of the axis, permissible jerk of the axis, permissible tangential acceleration, and permissible normal acceleration, the servo parameter includes at least one of position loop gain and feedforward gain, the control parameter defined for each function includes at least a tolerance of a smoothing process, and ON/OFF of the function includes at least ON/OFF of oscillating motion.

6. The numerical controller according to claim 1, wherein the control condition setting unit sets a control mode in the control region to a control mode different from a control mode in a region other than the control region.

7. The numerical controller according to claim 6, wherein the control condition setting unit switches the control mode based on a priority indicator.

8. The numerical controller according to claim 7, wherein the priority indicator includes at least an execution time.
